(19) United States
(12) Patent Application Publication
(10) Pub. No.: US 2015/0232612 A1
(43) Pub. Date: Aug. 20, 2015

(54) MODIFIER FOR CELLULOSE ESTER RESINS, CELLULOSE ESTER OPTICAL FILM, AND POLARIZING-PLATE PROTECTIVE FILM

(71) Applicant: DIC Corporation, Tokyo (JP)

(72) Inventors: Yusuke Tajiri, Ichihara-shi (JP); Masato Ishiyama, Ichihara-shi (JP)

(21) Appl. No.: 14/420,503

(22) PCT Filed: Aug. 7, 2013
(86) PCT No.: PCT/JP2013/071393

§ 371 Date: Feb. 9, 2015

(30) Foreign Application Priority Data
Aug. 16, 2012 (JP) 2012-180501

(51) Int. Cl. C08G 63/199; G02B 1/14; C08J 5/18

(52) U.S. Cl. CPC C08G 63/199; C08J 5/18; G02B 1/14; C08J 2301/12; C08J 2367/02

(57) ABSTRACT

To provide a modifier for cellulose ester resins that allows a decrease in retardation value (Rth) in the thickness direction of a film, that can impart resistance to moisture permeation, and that can provide a film whose Rth value tends not to vary in response to variation in humidity; a cellulose ester optical film including the modifier; and a polarizing-plate protective film including the modifier. Provided are a modifier that includes a polyester resin (A) having a structure represented by a general formula (1) or a general formula (2) below; a cellulose ester optical film including the modifier and a cellulose ester resin; and a polarizing-plate protective film obtained by casting a resin solution onto a metal support, the resin solution being prepared by dissolving in an organic solvent the modifier and a cellulose ester resin and by subsequently drying the resin solution through evaporation of the organic solvent.

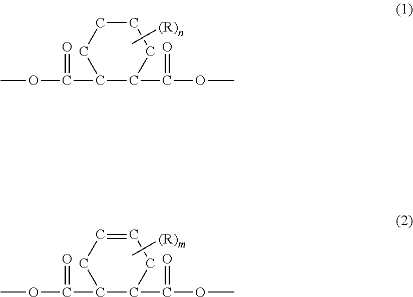

### TECHNICAL FIELD

The present invention relates to a modifier for cellulose ester resins, the modifier being usable for various applications including optical films such as polarizing-plate protective films; a cellulose ester optical film including the modifier; and a polarizing-plate protective film including the modifier.

### BACKGROUND ART

In recent years, notebook computers, televisions, and information appliances such as cellular phones that have liquid crystal display units allowing clear displaying of images and letters have been continuously supplied to the market. Consumers demand such information appliances having, for example, advanced sophisticated functions. In particular, enhancement of visibility (increase in the viewing angle) of such a liquid crystal display unit is an important factor that governs the value of the product. This is also strongly demanded by consumers.

In general, such a liquid crystal display unit is a multilayer structure in which two glass substrates sandwich an electrode layer and a layer formed of a liquid crystal substance (liquid crystal layer) therebetween. To a surface of each glass substrate, the surface being on an opposite side with respect to the liquid crystal layer, a polarizing plate is attached. Such a polarizing plate commonly used has a configuration in which protective films are attached to both surfaces of a polarizer formed of polyvinyl alcohol (PVA). Such protective films commonly used are cellulose ester films that have high transparency, high optical isotropy, and appropriate strength, and that exhibit high adhesion to PVA.

However, cellulose ester films, which have high optical isotropy within the film plane, have optical anisotropy in the thickness direction. Thus, viewing obliquely a liquid crystal display screen having a cellulose ester film can provide images that do not have colors supposed to be displayed. For this reason, in order to optimize visibility of the liquid crystal display unit at an oblique angle, the display unit has needed to be optically designed by determining the degree of optical anisotropy in the thickness direction of the film and by being based on this degree.

In general, the degree of optical anisotropy of an optical film can be determined on the basis of retardation values. Among retardation values of an optical film, a retardation value in the film thickness direction (hereafter also referred to as “Rth”) is defined by the following formula (1).

Rth=[(nx+ny)/2−nz]×d (1)

[in the formula, nx represents a refractive index in the slow axis direction within the film plane; ny represents a refractive index in the fast axis direction within the film plane; nz represents a refractive index in the film thickness direction; and d represents the thickness (nm) of the film.]

The above-described cellulose ester films function as protective films for polarizers. However, ordinary films cannot sufficiently prevent entry of moisture (water) from the outside into polarizers. This sometimes results in deterioration of polarizers or separation of polarizers from the films. For this reason, attempts to enhance resistance to moisture permeation have been carried out by using films formed of the cellulose ester resin and a plasticizer such as triphenyl phosphate (TPP), as, for example, “polarizing-plate protective films” or the like.

However, use of existing plasticizers such as TPP commonly used for cellulose ester films cannot provide cellulose ester films that have sufficient resistance to moisture permeation and a Rth that is sufficiently low on the practical level, ideally, a Rth that is close to zero.

There is a disclosure of a modifier for cellulose ester resins (for example, refer to Patent Literature 1), the modifier allowing a decrease in retardation value (Rth) in the thickness direction of a cellulose ester film to a value that is sufficient on the practical level, the modifier also imparting high resistance to moisture permeation to the film: for example, the modifier for cellulose ester resins is an aliphatic polyester (A) having a number-average molecular weight of 1000 to 3000 and obtained by causing a reaction between a glycol (a) having 2 to 4 carbons, an aliphatic dicarboxylic acid (b) having 2 to 6 carbons, and a monoalcohol and/or a monocarboxylic acid (c) having 4 to 9 carbons. Specifically, this Patent Literature 1 discloses an aliphatic polyester resin that has a number-average molecular weight of 1500 and is obtained by causing a reaction between propylene glycol, succinic acid, and 1-butanol. However, cellulose ester films formed with the modifier disclosed in Patent Literature 1 have a Rth value that tends to vary in response to variation in the ambient humidity. For this reason, liquid crystal display units having such films have problems of deterioration of image quality occurring in a high-humidity environment.

### CITATION LIST

### Patent Literature

PTL 1: Japanese Unexamined Patent Application Publication No. 2009-046531

### SUMMARY OF INVENTION

### Technical Problem

An object of the present invention is to provide a modifier for cellulose ester resins that allows a decrease in retardation value (Rth) in the thickness direction of a cellulose ester film to a value that is sufficient on the practical level, ideally, a value that is close to zero, that can impart resistance to moisture permeation to a film containing a cellulose ester resin, and that can provide a film whose Rth value tends not to vary in response to variation in humidity; a cellulose ester film including the modifier; and a polarizing-plate protective film including the modifier.

### Solution to Problem

The inventors of the present invention performed thorough studies. As a result, the inventors have found that, for example, the above-described object can be achieved with a polyester-resin-based modifier that has a cyclohexane ring or a cyclohexene ring in a main-chain skeleton and that is a polymer formed through ester bonds at the 1 and 2 positions of such rings. Thus, the inventors have accomplished the present invention.

That is, the present invention provides a modifier for cellulose ester resins that includes a polyester resin (A) having a structure represented by a general formula (1) or a general formula (2) below

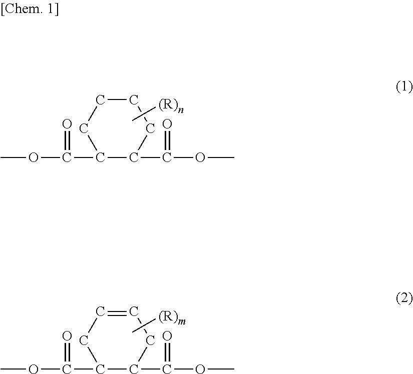

(in the formulae, R's each represent a hydrogen atom or an alkyl group having 1 to 4 carbon atoms; n represents an integer of 1 to 10; and m represents an integer of 1 to 8).

The present invention also provides a cellulose ester film including the above-described modifier for cellulose ester resins and a cellulose ester resin.

Furthermore, the present invention provides a polarizing-plate protective film obtained by casting a resin solution onto a metal support, the resin solution being prepared by dissolving in an organic solvent the above-described modifier for cellulose ester resins and a cellulose ester resin; and by subsequently drying the resin solution through evaporation of the organic solvent.

### Advantageous Effects of Invention

The present invention can provide a modifier for cellulose ester resins that allows a decrease in retardation value (Rth) in the thickness direction of a cellulose ester film to a value that is sufficient on the practical level. In addition, use of this modifier can provide a cellulose ester film having high resistance to moisture permeation. In this film, the Rth value tends not to vary in response to variation in humidity, which is also advantageous. The film having such excellent characteristics can be preferably used as, for example, a polarizing-plate protective film, an optical compensation film, or a phase-difference film.

### DESCRIPTION OF EMBODIMENTS

A modifier for cellulose ester resins according to the present invention includes a polyester resin (A) having, in the main-chain skeleton, a structure represented by a general formula (1) or a general formula (2) below.

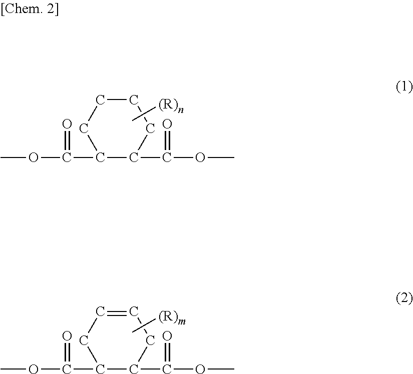

(In the formulae, R's each represent a hydrogen atom or an alkyl group having 1 to 4 carbon atoms; n represents an integer of 1 to 10; and m represents an integer of 1 to 8.)

The polyester resin (A) can obtained by, for example, a reaction between a dihydric alcohol and a dibasic acid including, as an aliphatic dibasic acid, a dibasic acid having a cyclohexane ring and carboxyl groups at the 1 and 2 positions of the cyclohexane ring or a dibasic acid having a cyclohexene ring and carboxyl groups at the 1 and 2 positions of the cyclohexene ring.

Examples of the dibasic acid having a cyclohexane ring and carboxyl groups at the 1 and 2 positions of the cyclohexane ring include 1,2-dicarboxycyclohexane, 1,2-dicarboxy-3-methyl-cyclohexane, and 1,2-dicarboxy-4-methyl-cyclohexane. These may be used alone or in combination of two or more thereof. Anhydrides of these dibasic acids may be used.

Examples of the dibasic acid having a cyclohexene ring and carboxyl groups at the 1 and 2 positions of the cyclohexene ring include 1,2-dicarboxycyclohexene, 1,2-dicarboxy-3-methyl-cyclohexene, and 1,2-dicarboxy-4-methyl-cyclohexene. These may be used alone or in combination of two or more thereof. Anhydrides of these dibasic acids may be used.

Among the above-described dibasic acids, preferred are 1,2-dicarboxycyclohexane and 1,2-dicarboxycyclohexene because cellulose ester films having high resistance to moisture permeation can be obtained. Accordingly, among modifiers for cellulose ester resins according to the present invention, preferred are modifiers for cellulose ester resins, the modifiers being obtained by a reaction between a dihydric alcohol and a dibasic acid including 1,2-dicarboxycyclohexane or 1,2-dicarboxycyclohexene.

For a modifier for cellulose ester resins according to the present invention, in addition to the dibasic acid having a cyclohexane ring and carboxyl groups at the 1 and 2 positions of the cyclohexane ring or the dibasic acid having a cyclohexene ring and carboxyl groups at the 1 and 2 positions of the cyclohexene ring, another dibasic acid may be used for the purpose of controlling miscibility of the modifier with a cellulose ester resin. Examples of such another dibasic acid include aliphatic dibasic acids and aromatic dibasic acids.

Examples of the aliphatic dibasic acids include aliphatic dibasic acids having 2 to 6 carbon atoms: specifically, for example, malonic acid, succinic acid, glutaric acid, adipic acid, maleic acid, and fumaric acid. These may be used alone or in combination of two or more thereof.

Examples of the aromatic dibasic acids include phthalic acid, terephthalic acid, isophthalic acid, 1,5-naphthalenedicarboxylic acid, and 1,4-naphthalenedicarboxylic acid. These may be used alone or in combination of two or more thereof.

Among the dibasic acids additionally used, aliphatic dibasic acids are preferable, in particular, succinic acid is preferable. This is because modifiers for cellulose ester resins can be provided, the modifiers allowing a lower retardation value (Rth) in the thickness direction of cellulose-ester-resin-containing films.

The amount of the dibasic acid having a cyclohexane ring and carboxyl groups at the 1 and 2 positions of the cyclohexane ring or the dibasic acid having a cyclohexene ring and carboxyl groups at the 1 and 2 positions of the cyclohexene ring is preferably 5 to 100 parts by mass relative to 100 parts by mass of the total of dibasic acid. This can provide a modifier for cellulose ester resins that can further suppress variation in Rth value in response to variation in humidity. The above-described amount is more preferably 15 to 100 parts by mass.

Preferred examples of the dihydric alcohol include aliphatic alcohols having 2 to 4 carbon atoms. Examples of these alcohols include ethylene glycol, 1,2-propylene glycol, 1,3-propanediol, 2-methylpropanediol, 1,2-butanediol, 1,3-butanediol, 1,4-butanediol, and 2,3-butanediol. Among these, preferred are ethylene glycol and 1,2-propylene glycol because modifiers for cellulose ester resins can be obtained, the modifiers sufficiently imparting resistance to moisture permeation to cellulose ester films. These may be used alone or in combination of two or more thereof.

Among such polyester resins (A), a polyester resin that can be obtained by a reaction between such a dibasic acid and a dihydric alcohol has a hydroxyl group or a carboxyl group at an end of the resin. Such a hydroxyl group or a carboxyl group may be subjected to a reaction with a compound having a reactive group that can react with such a group. Such a reaction results in end capping so that higher resistance to moisture permeation can be imparted to cellulose ester films, which is advantageous.

In order to obtain a modifier in which the polyester resin (A) is end-capped, for example, the following methods are preferably used.

Method 1: a method in which a monocarboxylic acid, a dihydric alcohol, and a dibasic acid including a dibasic acid having a cyclohexane ring and carboxyl groups at the 1 and 2 positions of the cyclohexane ring or a dibasic acid having a cyclohexene ring and carboxyl groups at the 1 and 2 positions of the cyclohexene ring are collectively charged into a reaction system and caused to react.

Method 2: a method of causing a reaction between a dihydric alcohol and a dibasic acid including a dibasic acid having a cyclohexane ring and carboxyl groups at the 1 and 2 positions of the cyclohexane ring or a dibasic acid having a cyclohexene ring and carboxyl groups at the 1 and 2 positions of the cyclohexene ring to provide a polyester resin having a hydroxyl group at an end of the resin, and subsequently causing a reaction between this polyester resin and a monocarboxylic anhydride.

Method 3: a method in which a monoalcohol, a dihydric alcohol, and a dibasic acid including a dibasic acid having a cyclohexane ring and carboxyl groups at the 1 and 2 positions of the cyclohexane ring or a dibasic acid having a cyclohexene ring and carboxyl groups at the 1 and 2 positions of the cyclohexene ring are collectively charged into a reaction system and caused to react.

Method 4: a method of causing a reaction between a dihydric alcohol and a dibasic acid including a dibasic acid having a cyclohexane ring and carboxyl groups at the 1 and 2 positions of the cyclohexane ring or a dibasic acid having a cyclohexene ring and carboxyl groups at the 1 and 2 positions of the cyclohexene ring to provide a polyester resin having a carboxyl group at an end of the resin, and subsequently causing a reaction between this polyester resin and a monoalcohol.

Preferred examples of the monocarboxylic acid include monocarboxylic acids having 2 to 9 carbon atoms such as acetic acid, propanoic acid, butanoic acid, pentanoic acid, hexanoic acid, heptanoic acid, octanoic acid, 2-ethylhexyl acid, and nonanoic acid; and anhydrides of the monocarboxylic acids. These may be used alone or in combination of two or more thereof.

Preferred examples of the monoalcohol include monoalcohols having 4 to 9 carbons such as 1-butanol, 2-butanol, isobutanol, t-butanol, 1-pentanol, isopentyl alcohol, tert-pentyl alcohol, cyclopentanol, 1-hexanol, cyclohexanol, 1-heptanol, 1-octanol, 2-ethyl-1-hexanol, isononyl alcohol, and 1-nonyl alcohol. These may be used alone or in combination of two or more thereof.

During the capping of ends, it is not necessary to cap all the carboxyl groups or hydroxyl groups at ends and some carboxyl groups or some hydroxyl groups may be left at ends.

The acid value of the polyester resin (A) is preferably 3 or less, more preferably 1 or less, because high resistance to moisture permeation can be imparted to films and the stability of the modifier for cellulose ester resins can be maintained. The hydroxyl value is preferably 200 or less, more preferably 150 or less.

The polyester resin (A) can be produced by, for example, subjecting the above-described starting materials to an esterification reaction, if necessary, in the presence of an esterification catalyst, for example, in the temperature range of 180° C. to 250° C. for 10 to 25 hours. Note that conditions of the esterification reaction such as temperature and time are not particularly limited and may be appropriately set.

Examples of the esterification catalyst include titanium-based catalysts such as tetraisopropyltitanate and tetrabutyltitanate; tin-based catalysts such as dibutyltin oxide; and organic sulfonic acid-based catalysts such as p-toluenesulfonic acid.

The amount of the esterification catalyst used may be appropriately set. In general, this amount is preferably 0.001 to 0.1 parts by mass relative to 100 parts by mass of the total of the starting materials.

The polyester resin (A) preferably has a number-average molecular weight (Mn) in the range of 500 to 3,000, more preferably in the range of 500 to 1,500, because it has higher miscibility with cellulose ester resins.

Herein, the number-average molecular weight (Mn) is a value determined in terms of polystyrene on the basis of gel permeation chromatography (GPC) measurement. Note that conditions for the GPC measurement are as follows.

[GPC measurement conditions]

Measurement instrument: “HLC-8220 GPC” manufactured by Tosoh Corporation

Columns: guard column “HHR-H” (6.0 mm I.D.×4 cm) manufactured by Tosoh Corporation+“TSK-GEL GMHHR-N” (7.8 mm I.D.×30 cm) manufactured by Tosoh Corporation+“TSK-GEL GMHHR-N” (7.8 mm I.D.×30 cm) manufactured by Tosoh Corporation+“TSK-GEL GMHHR-N” (7.8 mm I.D.×30 cm) manufactured by Tosoh Corporation+“TSK-GEL GMHHR-N” (7.8 mm I.D.×30 cm) manufactured by Tosoh Corporation

Detector: ELSD (“ELSD2000” manufactured by Alltech associates, Inc.)

Data processing: “GPC-8020 model II data analysis version 4.30” manufactured by Tosoh Corporation

Measurement conditions: Column temperature 40° C.
Developing solvent
   tetrahydrofuran (THF)
Flow rate 1.0 ml/min

Samples: obtained by filtering 1.0 mass % resin solution in terms of solid content in tetrahydrofuran through a microfilter (5 μl)

Standard samples: the following monodisperse polystyrenes having known molecular weights were used on the basis of the measurement manual of the “GPC-8020 model II data analysis version 4.30”.

### (Monodisperse Polystyrenes)

“A-500” manufactured by Tosoh Corporation

“A-1000” manufactured by Tosoh Corporation

“A-2500” manufactured by Tosoh Corporation

“A-5000” manufactured by Tosoh Corporation

“F-1” manufactured by Tosoh Corporation

“F-2” manufactured by Tosoh Corporation

“F-4” manufactured by Tosoh Corporation

“F-10” manufactured by Tosoh Corporation

“F-20” manufactured by Tosoh Corporation

“F-40” manufactured by Tosoh Corporation

“F-80” manufactured by Tosoh Corporation

“F-128” manufactured by Tosoh Corporation

“F-288” manufactured by Tosoh Corporation

“F-550” manufactured by Tosoh Corporation

Properties of the polyester resin (A) vary depending on the number-average molecular weight (Mn), composition, or the like. In general, the polyester resin (A) is in the form of liquid, solid, paste, or the like at room temperature.

A modifier for cellulose ester resins according to the present invention contains the polyester resin (A). A modifier for cellulose ester resins according to the present invention may be a modifier containing the polyester resin (A) alone or may also contain a polyester other than the polyester resin (A). The modifier may contain a modifier other than polyesters or may contain unreacted compounds of starting materials used for producing the polyester resin (A).

A modifier according to the present invention may be mixed with a cellulose ester resin to thereby provide a cellulose ester resin composition. Use of this composition allows formation of an optical film that has in the thickness direction a retardation value (Rth) sufficiently low on the practical level and has high resistance to moisture permeation in which the Rth value tends not to vary in response to variation in humidity.

Examples of the cellulose ester resin include resins in which a part of or all of the hydroxyl groups of cellulose obtained form cotton linter, wood pulp, kenaf, or the like are esterified. Among these resins, preferred are cellulose ester resins obtained by esterification of cellulose obtained form cotton linter because the resultant films are easily released from a metal support of a film formation apparatus so that the film production efficiency can be further increased.

Examples of the cellulose ester resin include cellulose acetate, cellulose acetate propionate, cellulose acetate butyrate, cellulose acetate phthalate, and cellulose nitrate. In a case of using the cellulose ester optical film as a polarizing-plate protective film, cellulose acetate is preferably used because a film excellent in terms of mechanical properties and transparency can be obtained. Such cellulose ester resins may be used alone or in combination of two or more thereof.

The cellulose acetate preferably has a degree of polymerization of 250 to 400 and a degree of acetylation of 54.0% to 62.5% by mass, more preferably 58.0% to 62.5% by mass. Such a cellulose acetate having a degree of polymerization and a degree of acetylation that satisfy such ranges allows formation of a film excellent in terms of mechanical properties. In the present invention, what is called cellulose triacetate is more preferably used. Note that the term “degree of acetylation” in the present invention denotes the mass ratio of acetic acid generated by saponifying cellulose acetate relative to the total mass of the cellulose acetate.

Specific examples of the cellulose acetate include cellulose diacetate and cellulose triacetate. In particular, cellulose triacetate is preferred.

The cellulose acetate preferably has a number-average molecular weight (Mn) in the range of 70,000 to 300,000, more preferably in the range of 80,000 to 200,000. Such a cellulose acetate having a (Mn) satisfying such a range allows formation of a film excellent in terms of mechanical properties.

The amount of a modifier for cellulose ester resins according to the present invention in the cellulose ester resin composition relative to 100 parts by mass of the cellulose ester resin is preferably in the range of 5 to 30 parts by mass, more preferably in the range of 5 to 15 parts by mass. Use of the modifier for cellulose ester resins in such a range provides a composition that allows formation of a cellulose ester optical film having resistance to moisture permeation and a low Rth.

Hereinafter, a cellulose ester film containing a cellulose ester resin and a modifier for cellulose ester resins according to the present invention will be described.

A cellulose ester film according to the present invention contains the cellulose ester resin, the modifier for cellulose ester resins, and, if necessary, other various additives or the like. In particular, this cellulose ester film can be preferably used as a cellulose ester optical film for optical applications. The film thickness of a cellulose ester film according to the present invention varies depending on the application. In general, the film thickness is preferably in the range of 10 to 200 μm.

A cellulose ester film according to the present invention can also be obtained with a cellulose ester resin composition containing the cellulose ester resin and the modifier for cellulose ester resins.

The cellulose ester optical film may have a characteristic such as optical anisotropy or optical isotropy. In a case of using the optical film as a polarizing-plate protective film, an optically isotropic film that does not block passing of light therethrough is preferably used.

The cellulose ester optical film can be used for various applications. This film is most effectively used as, for example, a polarizing-plate protective film for a liquid crystal display unit, the film being required to have optical isotropy. It can also be used as a support for a polarizing-plate protective film, the support being required to have an optical compensation function.

The cellulose ester optical film can be used for liquid crystal cells with various display modes. Examples of the modes include IPS (in-plane switching), TN (twisted nematic), VA (vertically aligned), and OCB (optically compensatory bend). In particular, the optical film is preferably used for the IPS mode.

The amount of a modifier for cellulose ester resins according to the present invention contained in a cellulose ester optical film according to the present invention relative to 100 parts by mass of the cellulose ester resin is preferably in the range of 5 to 30 parts by mass, more preferably in the range of 5 to 15 parts by mass. Use of such a modifier for cellulose ester resins satisfying such a range allows formation of a cellulose ester optical film having resistance to moisture permeation and a low Rth.

The cellulose ester optical film can be obtained in the following manner: a cellulose ester resin composition containing the cellulose ester resin, the modifier for cellulose ester resins, and, if necessary, other various additives or the like is melted and kneaded with, for example, an extruder and shaped into a film with a T die or the like. Alternatively, instead of the cellulose ester resin and the modifier for cellulose ester resins, the cellulose ester resin composition may be used.

Another example of the method for forming the cellulose ester optical film (what is called solvent casting method) is as follows: a resin solution is cast onto a metal support, the resin solution being obtained by dissolving the cellulose ester resin and the modifier for cellulose ester resins in an organic solvent; and the resin solution is subsequently dried through evaporation of the organic solvent.

The solvent casting method can suppress alignment of the cellulose ester resin within the film being formed. Thus, the resultant film substantially has optical isotropy. The film having optical isotropy can be used as an optical material for, for example, liquid crystal displays; in particular, it is useful as a polarizing-plate protective film. The film obtained by the method tends not to have irregularities in the surface and has high surface smoothness.

In general, the solvent casting method includes a first step of dissolving in an organic solvent the cellulose ester resin and the modifier for cellulose ester resins to provide a resin solution and casting the resin solution onto a metal support; a second step of drying the cast resin solution through evaporation of the organic solvent contained in the solution to form a film; and a third step of subsequently releasing from the metal support the film formed on the metal support and drying the film by heating.

The metal support used in the first step is, for example, a support formed of metal and having the shape of an endless belt or a drum. For example, a support formed of stainless steel and having a mirror-finish surface can be used.

During the casting of a resin solution onto the metal support, in order to suppress entry of foreign matter into a film to be formed, the resin solution used is preferably a resin solution having been filtered through a filter.

The drying process in the second step is not particularly limited, but it can be carried out in the following manner: for example, a gas in a temperature range of 30° C. to 50° C. is blown to the upper surface and/or the lower surface of the metal support to thereby evaporate 50% to 80% by mass of the organic solvent contained in the cast resin solution, so that a film is formed on the metal support.

Subsequently, the third step is carried out in the following manner: the film formed in the second step is released from the metal support and dried by heating at a temperature higher than that in the second step. This drying by heating is preferably carried out by, for example, increasing temperature in a stepwise manner under a temperature condition of 100° C. to 160° C. because high dimensional stability can be achieved. As a result of drying by heating under the temperature condition, the organic solvent remaining within the film provided by the second step can be substantially completely removed.

Note that, in the first step to the third step, the organic solvent may be collected and used again.

During the mixing and dissolving of the cellulose ester resin and the modifier for cellulose ester resins in an organic solvent, the organic solvent usable is not particularly limited as long as it can dissolve the resin and the modifier. For example, in a case of using cellulose acetate as a cellulose ester, preferred examples of a good solvent include organic halogen compounds such as methylene chloride and dioxolanes.

Preferred is use of such a good solvent in combination with a poor solvent such as methanol, ethanol, 2-propanol, n-butanol, cyclohexane, and cyclohexanone for the purpose of increasing the film production efficiency.

The mixing ratio (mass ratio) of the good solvent to the poor solvent is preferably good solvent/poor solvent=75/25 to 95/5.

The concentration of the cellulose ester resin in the resin solution is preferably 10% to 50% by mass, more preferably 15% to 35% by mass.

The cellulose ester optical film may contain various additives as long as an object of the present invention is achieved.

Examples of the additives include modifiers other than modifiers for cellulose ester resins according to the present invention, thermoplastic resins, ultraviolet absorbers, matting agents, degradation prevention agents (for example, antioxidants, peroxide decomposers, radical inhibitors, metal deactivators, and acid acceptors), and dyes. Use of such additives is not particularly limited: the additives may be added together with the cellulose ester resin and the modifier for cellulose ester resins during mixing and dissolving of the cellulose ester resin and the modifier in the organic solvent; alternatively, the additives may be added separately.

Examples of the modifiers other than the modifiers for cellulose ester resins include phosphoric esters such as triphenyl phosphate (TPP), tricresyl phosphate, and cresyl diphenyl phosphate; phthalic esters such as dimethyl phthalate, diethyl phthalate, dibutyl phthalate, and di-2-ethylhexyl phthalate; ethyl phthalyl ethyl glycolate, butyl phthalyl butyl glycolate, trimethylolpropane tribenzoate, pentaerythritol tetraacetate, and tributyl acetylcitrate.

The thermoplastic resins are not particularly limited and examples thereof include polyester resins other than modifiers for cellulose ester resins according to the present invention, polyester ether resins, polyurethane resins, epoxy resins, and toluenesulfonamide resins.

The ultraviolet absorbers are not particularly limited and examples thereof include oxybenzophenone-based compounds, benzotriazole-based compounds, salicylic ester-based compounds, benzophenone compounds, cyanoacrylate-based compounds, and nickel complex salt-based compounds. The amount of such an ultraviolet absorber is preferably in the range of 0.01 to 2 parts by mass relative to 100 parts by mass of the cellulose ester resin.

Examples of the matting agents include silicon oxide, titanium oxide, aluminum oxide, calcium carbonate, calcium silicate, aluminum silicate, magnesium silicate, calcium phosphate, kaoline, and talc. The amount of such a matting agent is preferably in the range of 0.1 to 0.3 parts by mass relative to 100 parts by mass of the cellulose ester resin.

The dyes are not particularly limited in terms of type, amount of addition, or the like as long as an object of the present invention is achieved.

A cellulose ester optical film according to the present invention has high resistance to moisture permeation, high transparency, and sufficiently low optical anisotropy in the thickness direction and hence can be used as, for example, an optical film for a liquid crystal display unit. Examples of such an optical film for a liquid crystal display unit include a polarizing-plate protective film, a phase-difference film, a reflecting film, a viewing-angle-enhancement film, an antiglare film, an anti-reflection film, an antistatic film, and a color filter. Of these, use as the polarizing-plate protective film is preferred.

The cellulose ester optical film preferably has a thickness in the range of 20 to 120 μm, more preferably in the range of 25 to 100 μm, particularly preferably in the range of 25 to 80 μm. In a case where the optical film is used as a polarizing-plate protective film, a film thickness in the range of 25 to 80 μm is suitable for achieving reduction in the thickness of a liquid crystal display unit and also allows maintaining of excellent properties in terms of, for example, sufficient film strength, Rth stability, and resistance to moisture permeation.

In particular, a cellulose ester optical film according to the present invention has a retardation value (Rth) on a very low level, that is, in the range of 5 to −15 nm. Specifically, after a cellulose ester optical film according to the present invention is left at rest in an environment at 25° C. and at a relative humidity of 20% for 12 hours, the Rth value of the optical film at a wavelength of 590 nm is measured and found to be 5 to −15 nm. This measurement of the Rth value can be carried out with a birefringence analyzer “KOBRA-WR” manufactured by Oji Scientific Instruments. Thus, the optical film is very useful as a material having high optical isotropy.

One advantage of a cellulose ester optical film according to the present invention is that, as described above, variation in Rth value (ΔRth value) in response to variation in humidity is small. Specifically, a cellulose ester optical film according to the present invention is left at rest in an environment at 25° C. and at a relative humidity of 35% for 12 hours, and the Rth value of the optical film at a wavelength of 590 nm is measured; subsequently, the optical film is left at rest in an environment at 25° C. and at a relative humidity of 85% for 12 hours, and the Rth value of the optical film at a wavelength of 590 nm is measured. As a result, the absolute value of difference in Rth (ΔRth value) is 4 to 10.

In summary, a cellulose ester optical film according to a preferred embodiment of the present invention is as follows: after the optical film is left at rest in an environment at 25° C. and at a relative humidity of 20% for 12 hours, the Rth value of the optical film measured at a wavelength of 590 nm is found to be 5 to −15 nm; and when the optical film is left at rest in an environment at 25° C. and at a relative humidity of 35% for 12 hours, the Rth value of the optical film at a wavelength of 590 nm is measured, subsequently, the optical film is left at rest in an environment at 25° C. and at a relative humidity of 85% for 12 hours, the Rth value of the optical film at a wavelength of 590 nm is measured, and the absolute value of difference in Rth (ΔRth value) is 4 to 10.

The polarizing-plate protective film can be adjusted so as to have a desired Rth without the occurrence of bleeding at high temperature and high humidity. Accordingly, the polarizing-plate protective film can be widely used for various liquid crystal displaying modes depending on the application.

The cellulose ester optical film and the polarizing-plate protective film have high resistance to moisture permeation, a Rth on a very low level, and low optical anisotropy, and hence can be used as, for example, an optical film for a liquid crystal display unit or a support for a silver halide photosensitive material. The optical film is not particularly limited and examples thereof include a polarizing-plate protective film, a phase-difference film, a reflecting plate, a viewing-angle-enhancement film, an antiglare film, an anti-reflection film, an antistatic film, and a color filter. Among the above-described cellulose ester optical films, films having the above-described excellent properties and a low Rth can be used as a polarizing-plate protective film required to have optical isotropy and a support for a polarizing-plate protective film having a viewing-angle compensation function.

### EXAMPLES

Hereinafter, the present invention will be described more specifically with reference to Examples. Parts and % in EXAMPLES are based on mass unless otherwise specified.

### Example 1

### Modifier for Cellulose Ester Resins According to the Present Invention

To a 1-liter three-neck flask, 179 g of ethylene glycol (hereafter abbreviated as “EG”) and 219 g of 1,2-propylene glycol (hereafter abbreviated as “PG”) serving as glycol components, 700 g of 1,2-dicarboxycyclohexane (hereafter abbreviated as “HHPA”) serving as a dicarboxylic acid component, and 0.03 g of tetraisopropyltitanate (hereafter abbreviated as “TIPT”) serving as a catalyst were charged and caused to react, under a stream of nitrogen supplied through a nitrogen introduction tube, at 220° C. for 24 hours to thereby provide a polyester resin having a structure represented by the general formula (1) [modifier (1) for cellulose ester resins according to the present invention]. The obtained modifier (1) was a pale yellow liquid at room temperature and had an acid value of 0.57, a hydroxyl value of 112.2, and a number-average molecular weight of 980.

### Example 2

### Same as Above

To a 1-liter three-neck flask, 173 g of EG and 213 g of PG serving as glycol components, 348 g of HHPA and 267 g of succinic acid (hereafter abbreviated as “SA”) serving as dicarboxylic acid components, and 0.03 g of TIPT serving as a catalyst were charged and caused to react, under a stream of nitrogen supplied through a nitrogen introduction tube, at 220° C. for 24 hours to thereby provide a polyester resin having a structure represented by the general formula (1) [modifier (2) for cellulose ester resins according to the present invention]. The obtained modifier (2) was a pale yellow liquid at room temperature and had an acid value of 0.40, a hydroxyl value of 112.6, and a number-average molecular weight of 1210.

### Example 3

### Same as Above

To a 1-liter three-neck flask, 134 g of EG and 166 g of PG serving as glycol components, 207 g of n-butanol serving as a monohydric alcohol component, 403 g of HHPA and 309 g of SA serving as dicarboxylic acid components, and 0.03 g of TIPT serving as a catalyst were charged and caused to react, under a stream of nitrogen supplied through a nitrogen introduction tube, at 220° C. for 30 hours to thereby provide a polyester resin having a structure represented by the general formula (1) [modifier (3) for cellulose ester resins according to the present invention]. The obtained modifier (3) was a pale yellow liquid at room temperature and had an acid value of 0.40, a hydroxyl value of 2.6, and a number-average molecular weight of 980.

### Example 4

### Same as Above

To a 1-liter three-neck flask, 173 g of EG and 213 g of PG serving as glycol components, 348 g of HHPA and 267 g of SA serving as dicarboxylic acid components, and 0.03 parts of TIPT serving as a catalyst were charged and caused to react, under a stream of nitrogen supplied through a nitrogen introduction tube, at 220° C. for 24 hours. After the reaction, the resultant polyester polyol was mixed with 195 g of acetic anhydride and caused to react at 130° C. for 2 hours. After the reaction, acetic acid and an excess of the acetic anhydride were evaporated by reducing the pressure to thereby provide a polyester resin having a structure represented by the general formula (1) [modifier (4) for cellulose ester resins according to the present invention]. The obtained modifier (4) was a pale yellow liquid at room temperature and had an acid value of 0.40, a hydroxyl value of 0.5, and a number-average molecular weight of 1200.

### Example 5

### Same as Above

To a 1-liter three-neck flask, 202 g of EG and 247 g of PG serving as glycol components, 399 g of 1,2-dicarboxy-4-cyclohexene (hereafter abbreviated as “THPA”) and 310 g of SA serving as dicarboxylic acid components, and 0.03 g of TIPT serving as a catalyst were charged and caused to react, under a stream of nitrogen supplied through a nitrogen introduction tube, at 220° C. for 24 hours to thereby provide a polyester resin having a structure represented by the general formula (2) [modifier (5) for cellulose ester resins according to the present invention]. The obtained modifier (5) was a pale yellow liquid at room temperature and had an acid value of 0.58, a hydroxyl value of 118.0, and a number-average molecular weight of 1140.

### Example 6

### Same as Above

To a 1-liter three-neck flask, 217 g of EG serving as a glycol component, 163 g of n-butanol serving as a monohydric alcohol component, 208 g of HHPA and 372 g of SA serving as dicarboxylic acid components, and 0.03 g of TIPT serving as a catalyst were charged and caused to react, under a stream of nitrogen supplied through a nitrogen introduction tube, at 220° C. for 30 hours to thereby provide a polyester resin having a structure represented by the general formula (1) [modifier (6) for cellulose ester resins according to the present invention]. The obtained modifier (6) had the form of paste at room temperature and had an acid value of 0.43, a hydroxyl value of 5.4, and a number-average molecular weight of 810.

### Example 7

### Cellulose Ester Film According to the Present Invention

A triacetylcellulose resin (100 parts of “LT-35” manufactured by Daicel Corporation) and 10 parts of the modifier (1) for cellulose ester resins were added to and dissolved in a solvent mixture containing 810 parts of methylene chloride and 90 parts of methanol to thereby prepare a doping solution. This doping solution was cast onto a glass plate to a thickness of 0.8 mm and dried at room temperature for 16 hours, then at 50° C. for 30 minutes, and further at 120° C. for 30 minutes to thereby provide a cellulose ester film (1) according to the present invention. The obtained film (1) had a thickness of 60 μm.

The obtained cellulose ester film (1) was measured in terms of Rth, variation in Rth (ΔRth) in response to variation in humidity, and moisture permeability by methods described below. The measurement results are described in Table 1.

### <Method of Measuring Rth>

The cellulose ester film (1) was left at rest in an environment at 25° C. and at a relative humidity of 20% for 12 hours. After that, a Rth value at a wavelength of 590 nm was measured with a birefringence analyzer (KOBRA-WR manufactured by Oji Scientific Instruments).

### <Method of Measuring Variation in Rth (ΔRth) in Response to Variation in Humidity>

The cellulose ester film (1) was left at rest in an environment at 25° C. and at a relative humidity of 35% for 12 hours. After that, a Rth value at a wavelength of 590 nm was measured with a birefringence analyzer (KOBRA-WR manufactured by Oji Scientific Instruments). After the measurement, the film was left at rest in an environment at 25° C. and at a relative humidity of 85% for 12 hours and a Rth value was measured with the above-described analyzer. The absolute value of difference in measured Rth was determined and defined as ΔRth.

### <Method of Measuring Moisture Permeability>

The moisture permeability of the cellulose ester film (1) was measured on the basis of JIS Z 0208 and converted in terms of thickness of 60 μm. The measurement conditions were a temperature of 40° C. and a relative humidity of 90%.

### Examples 8 to 17

### Same as Above

Cellulose ester films (2) to (11) were obtained as in Example 7 except for mixing ratios described in Table 1. As in Example 7, the obtained cellulose ester films (2) to (11) were measured in terms of Rth, variation in Rth (ΔRth) in response to variation in humidity, and moisture permeability. The measurement results are described in Table 1.

### Comparative Example 1

### Comparative Modifier for Cellulose Ester Resins

To a 1-liter three-neck flask, 341 g of EG serving as a glycol component, 659 g of adipic acid (hereafter abbreviated as “AA”) serving as a dicarboxylic acid component, and 0.03 g of TIPT serving as a catalyst were charged and caused to react, under a stream of nitrogen supplied through a nitrogen introduction tube, at 220° C. for 24 hours to thereby provide a comparative modifier (1′) for cellulose ester resins. The obtained modifier (1′) was a white waxy solid at room temperature and had an acid value of 0.19, a hydroxyl value of 112.2, and a number-average molecular weight of 1410.

### Comparative Example 2

### Same as Above

To a 1-liter three-neck flask, 186 g of EG and 222 g of PG serving as glycol components, 592 g of SA serving as a dicarboxylic acid component, and 0.03 g of TIPT serving as a catalyst were charged and caused to react, under a stream of nitrogen supplied through a nitrogen introduction tube, at 220° C. for 24 hours to thereby provide a comparative modifier (2′) for cellulose ester resins. The obtained modifier (2′) was a pale yellow liquid at room temperature and had an acid value of 0.20, a hydroxyl value of 113.0, and a number-average molecular weight of 1120.

### Comparative Example 3

### Same as Above

To a 1-liter three-neck flask, 119 g of EG and 146 g of PG serving as glycol components, 182 g of n-butanol serving as a monohydric alcohol component, 545 g of SA serving as a dicarboxylic acid component, and 0.03 g of TIPT serving as a catalyst were charged and caused to react, under a stream of nitrogen supplied through a nitrogen introduction tube, at 220° C. for 30 hours to thereby provide a comparative modifier (3′) for cellulose ester resins. The obtained modifier (3′) was a pale yellow liquid at room temperature and had an acid value of 0.28, a hydroxyl value of 2.6, and a number-average molecular weight of 980.

### Comparative Example 4

### Same as Above

To a 1-liter three-neck flask, 150 g of EG and 183 g of PG serving as glycol components, 667 g of 1,4-cyclohexanedicarboxylic acid serving as a dicarboxylic acid component, and 0.03 g of TIPT serving as a catalyst were charged and caused to react, under a stream of nitrogen supplied through a nitrogen introduction tube, at 220° C. for 24 hours to thereby provide a comparative modifier (4′) for cellulose ester resins. The obtained modifier (4′) was a pale yellow liquid at room temperature and had an acid value of 0.32, a hydroxyl value of 99.7, and a number-average molecular weight of 1490.

### Comparative Example 5

### Same as Above

To a 1-liter three-neck flask, 204 g of EG and 250 g of PG serving as glycol components, 314 g of SA and 393 g of phthalic anhydride serving as dicarboxylic acid components, and 0.03 g of TIPT serving as a catalyst were charged and caused to react, under a stream of nitrogen supplied through a nitrogen introduction tube, at 220° C. for 24 hours to thereby provide a comparative modifier (5′) for cellulose ester resins. The obtained modifier (5′) was a pale yellow liquid at room temperature and had an acid value of 0.29, a hydroxyl value of 103.8, and a number-average molecular weight of 1190.

### Comparative examples 6 to 13

### Comparative Cellulose Ester Films

Comparative cellulose ester films (1′) to (8′) were obtained as in Example 7 except for mixing ratios described in Table 1. As in Example 6, the obtained cellulose ester films (1′) to (8′) were measured in terms of Rth, variation in Rth (ΔRth) in response to variation in humidity, and moisture permeability. The measurement results are described in Table 1.

TABLE 1

| | | | | | Amount of | | | |
|---|---|---|---|---|---|---|---|---|
| | | | | | modifier for | | | |
| | | Employed | Dibasic | End | cellulose ester resins | | | |
| | | modifier | acid used for synthesis | of modifier for | relative to 100 parts | | Moisture | |
| | Cellulose | for cellulose | of modifier for cellulose ester | cellulose | by mass of cellulose | Rth | permeability | ΔRth |
| | ester film | ester resins | resins | ester resins | ester resin (parts) | (nm) | (g/m²/24 hr) | (nm) |
| Example 7 | (1) | (1) | HHPA | OH | 10 | −1 | 600 | 6 |
| Example 8 | (2) | (1) | HHPA | OH | 15 | −12 | 500 | 4 |
| Example 9 | (3) | (2) | HHPA/SA[molar ratio = 5/5] | OH | 10 | 0 | 600 | 6 |
| Example 10 | (4) | (2) | HHPA/SA[molar ratio = 5/5] | OH | 15 | −9 | 510 | 5 |
| Example 11 | (5) | (2) | HHPA/SA[molar ratio = 5/5] | OH | 20 | −15 | 410 | 3 |
| Example 12 | (6) | (3) | HHPA/SA[molar ratio = 5/5] | Bu | 15 | −8 | 470 | 7 |
| Example 13 | (7) | (4) | HHPA/SA[molar ratio = 5/5] | Ac | 15 | −8 | 470 | 7 |
| Example 14 | (8) | (5) | THPA/SA[molar ratio = 5/5] | OH | 10 | −1 | 580 | 9 |
| Example 15 | (9) | (5) | THPA/SA[molar ratio = 5/5] | OH | 15 | −12 | 480 | 7 |
| Example 16 | (10) | (6) | HHPA/SA[molar ratio = 3/7] | Bu | 10 | −1 | 580 | 5 |
| Example 17 | (11) | (6) | HHPA/SA[molar ratio = 3/7] | Bu | 15 | −9 | 510 | 4 |
| Comparative example 6 | (1′) | (1′) | AA | OH | 10 | −5 | 680 | 10 |
| Comparative example 7 | (2′) | (1′) | AA | OH | 15 | −16 | 610 | 6 |
| Comparative example 8 | (3′) | (1′) | AA | OH | 20 | −23 | 620 | 4 |
| Comparative example 9 | (4′) | (2′) | SA | OH | 10 | −3 | 600 | 10 |
| Comparative example 10 | (5′) | (2′) | SA | OH | 15 | −14 | 580 | 8 |
| Comparative example 11 | (6′) | (3′) | SA | Bu | 15 | −14 | 550 | 10 |
| Comparative example 12 | (7′) | (4′) | CHDA | OH | 15 | 2 | 560 | 12 |
| Comparative example 13 | (8′) | (5′) | PA/SA[molar ratio = 5/5] | OH | 15 | 11 | 500 | 8 |

Footnote of Table 1
HHPA: 1,2-dicarboxycyclohexane
SA: succinic acid
THPA: 1,2-dicarboxycyclohexene
AA: adipic acid
CHDA: 1,4-cyclohexanedicarboxylic acid
PA: phthalic anhydride

The cellulose ester films obtained in Examples are stable optical films having a low moisture permeability and exhibiting a small variation in retardation (ΔRth) in response to variation in humidity. In contrast, regarding Comparative examples, resistance to moisture permeation, low Rth, and low ΔRth are all not satisfied.

### Test Examples 1 to 5 and Comparative Test Examples 1 to 3

The cellulose ester films (1), (3), (6), (8), and (10) and Comparative cellulose ester films (1′) and (4′) obtained in Examples and Comparative examples were used to evaluate the dimension stability of the films under moisture absorption by a method described below. The evaluation results are described in Table 2.

### <Method of Evaluating Dimension Stability>

The evaluation of dimension stability with respect to humidity was based on a ratio of expansion occurring in response to a change of relative humidity from 40% RH to 80%% RH. The expansion ratio was determined with a TMA-SS6100 equipped with a humidity control unit designed for high-temperature and high-humidity conditions (manufactured by Seiko Instruments Inc.): while a sample having a film thickness of 60 μm and a width of 3 mm was fixed with a tension mode under conditions of a load of 50 mN and a chuck-to-chuck distance of 20 mm and the sample was kept at a constant temperature of 40° C. within a furnace, the sample was dried with dry nitrogen having a humidity of 0% RH for 40 minutes, moistened at a humidity of 40% RH for 40 minutes, further moistened at a humidity of 80% RH for 40 minutes; and an expansion of the chuck-to-chuck distance from the moistening at 40% RH to the moistening at 80% RH was used to calculate the expansion ratio.

TABLE 2

| | Cellulose ester | |
|---|---|---|
| | optical film | Expansion ratio (%) |
| Test example 1 | (1) | 0.28 |
| Test example 2 | (3) | 0.30 |
| Test example 3 | (6) | 0.28 |
| Test example 4 | (8) | 0.30 |
| Test example 5 | (10) | 0.28 |
| Comparative test example 1 | (1′) | 0.36 |
| Comparative test example 2 | (4′) | 0.37 |

The cellulose ester films obtained in Examples exhibit a low expansion ratio with respect to variation in humidity and are optical films having dimension stability.

1. A modifier for cellulose ester resins, comprising a polyester resin (A) having a structure represented by a general formula (1) or a general formula (2) below 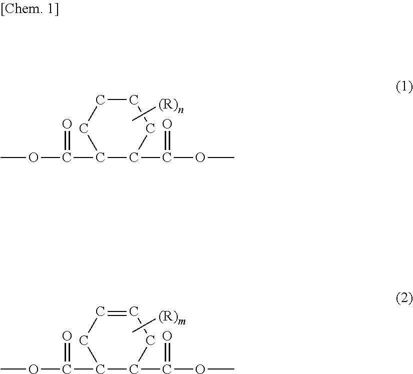
(in the formulae, R's each represent a hydrogen atom or an alkyl group having 1 to 4 carbon atoms; n represents an integer of 1 to 10; and m represents an integer of 1 to 8),
wherein the polyester resin (A) is obtained by a reaction between a dihydric aliphatic alcohol having 2 to 4 carbon atoms and a dibasic acid including 1,2-dicarboxycyclohexane or 1,2-dicarboxy-4-cyclohexene; and the modifier has an acid value of 3 or less, a hydroxyl value of 200 or less, and a number-average molecular weight of 500 to 3,000.

2. (canceled)

3. The modifier for cellulose ester resins according to claim 1, wherein the alcohol having 2 to 4 carbon atoms is ethylene glycol or 1,2-propylene glycol; and the modifier has an acid value of 1 or less, a hydroxyl value of 150 or less, and a number-average molecular weight of 500 to 1,500.

4. The modifier for cellulose ester resins according to claim 1, wherein the dibasic acid includes an aliphatic dibasic acid other than 1,2-dicarboxycyclohexane and 1,2-dicarboxy-4-cyclohexene.

5. The modifier for cellulose ester resins according to claim 1, wherein a content of the 1,2-dicarboxycyclohexane or the 1,2-dicarboxy-4-cyclohexene is 5 to 100 parts by mass relative to 100 parts by mass of a total of the dibasic acid.

6. The modifier for cellulose ester resins according to claim 1, wherein the polyester resin (A) is obtained by causing the reaction between the dihydric alcohol having 2 to 4 carbon atoms and the dibasic acid including 1,2-dicarboxycyclohexane or 1,2-dicarboxy-4-cyclohexene to prepare a polyester resin having a carboxyl group at an end of the resin, and by subsequently causing a reaction between the polyester resin and a monoalcohol.

7. A cellulose ester optical film obtained by a solvent casting method including a first step of dissolving in an organic solvent the cellulose ester resin and the modifier for cellulose ester resins according to claim 1 to provide a resin solution and casting the resin solution onto a metal support;
a second step of drying the cast resin solution through evaporation of the organic solvent contained in the solution to form a film; and
a third step of releasing from the metal support the film formed on the metal support and drying the film by heating,
wherein 5 to 15 parts by mass of the modifier for cellulose ester resins is used relative to 100 parts by mass of the cellulose ester resin, and
the second step is carried out in a temperature range of 30° C. to 50° C. and the third step is carried out in a range of 100° C. to 160° C.

8. The cellulose ester optical film according to claim 7, wherein the cellulose ester resin is triacetylcellulose.

9. The optical film according to claim 7, being intended to be used as a polarizing-plate protective film.

10. (canceled)

11. A cellulose ester optical film obtained by a solvent casting method including a first step of dissolving in an organic solvent the cellulose ester resin and the modifier for cellulose ester resins according to claim 3 to provide a resin solution and casting the resin solution onto a metal support;
a second step of drying the cast resin solution through evaporation of the organic solvent contained in the solution to form a film; and
a third step of releasing from the metal support the film formed on the metal support and drying the film by heating,
wherein 5 to 15 parts by mass of the modifier for cellulose ester resins is used relative to 100 parts by mass of the cellulose ester resin, and
the second step is carried out in a temperature range of 30° C. to 50° C. and the third step is carried out in a range of 100° C. to 160° C.

12. A cellulose ester optical film obtained by a solvent casting method including a first step of dissolving in an organic solvent the cellulose ester resin and the modifier for cellulose ester resins according to claim 4 to provide a resin solution and casting the resin solution onto a metal support;
a second step of drying the cast resin solution through evaporation of the organic solvent contained in the solution to form a film; and
a third step of releasing from the metal support the film formed on the metal support and drying the film by heating,
wherein 5 to 15 parts by mass of the modifier for cellulose ester resins is used relative to 100 parts by mass of the cellulose ester resin, and
the second step is carried out in a temperature range of 30° C. to 50° C. and the third step is carried out in a range of 100° C. to 160° C.

13. A cellulose ester optical film obtained by a solvent casting method including a first step of dissolving in an organic solvent the cellulose ester resin and the modifier for cellulose ester resins according to claim 5 to provide a resin solution and casting the resin solution onto a metal support;
a second step of drying the cast resin solution through evaporation of the organic solvent contained in the solution to form a film; and
a third step of releasing from the metal support the film formed on the metal support and drying the film by heating,
wherein 5 to 15 parts by mass of the modifier for cellulose ester resins is used relative to 100 parts by mass of the cellulose ester resin, and
the second step is carried out in a temperature range of 30° C. to 50° C. and the third step is carried out in a range of 100° C. to 160° C.

14. A cellulose ester optical film obtained by a solvent casting method including a first step of dissolving in an organic solvent the cellulose ester resin and the modifier for cellulose ester resins according to claim 6 to provide a resin solution and casting the resin solution onto a metal support;
a second step of drying the cast resin solution through evaporation of the organic solvent contained in the solution to form a film; and
a third step of releasing from the metal support the film formed on the metal support and drying the film by heating,
wherein 5 to 15 parts by mass of the modifier for cellulose ester resins is used relative to 100 parts by mass of the cellulose ester resin, and
the second step is carried out in a temperature range of 30° C. to 50° C. and the third step is carried out in a range of 100° C. to 160° C.

15. The cellulose ester optical film according to claim 11, wherein the cellulose ester resin is triacetylcellulose.

16. The cellulose ester optical film according to claim 12, wherein the cellulose ester resin is triacetylcellulose.

17. The cellulose ester optical film according to claim 13, wherein the cellulose ester resin is triacetylcellulose.

18. The cellulose ester optical film according to claim 14, wherein the cellulose ester resin is triacetylcellulose.

19. The optical film according to claim 8, being intended to be used as a polarizing-plate protective film.

20. The optical film according to claim 15, being intended to be used as a polarizing-plate protective film.

21. The optical film according to claim 16, being intended to be used as a polarizing-plate protective film.

22. The optical film according to claim 17, being intended to be used as a polarizing-plate protective film.
